(19) United States
(12) Patent Application Publication
(10) Pub. No.: US 2002/0170651 A1
(43) Pub. Date: Nov. 21, 2002

(54) Method for reinforcing cementitious structures

(76) Inventors: Christopher M. Edwards, Midland, MI (US); David Vanderpool, Wellesley Hills, MA (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/146,361

(22) Filed: May 15, 2002

Related U.S. Application Data
(60) Provisional application No. 60/291,102, filed on May 15, 2001.

(51) Int. Cl. B32B 35/00

(52) U.S. Cl. 156/94

(57) ABSTRACT

The present invention is a method for reinforcing a cementitious structure by contacting the structure with a fiber reinforced patch, wrapping, or insert contacting a heat-curable adhesive layer, then heat curing the adhesive. The patch or wrapping contains a fiber reinforcing layer affixed to a curable adhesive layer and the insert is typically an elongated fiber-reinforced composite surrounded by the heat curable resin and impregnating aligned fibers that extend longitudinally through the length of the composite.

### CROSS-REFERENCE STATEMENT

This application claims the benefit of U.S. Provisional application No. 60/291,102, filed May 15, 2001.

### BACKGROUND OF THE INVENTION

This invention relates to a method for reinforcing cementitious structures to resist or repair damage.

External reinforcement of cementitious structures is desirable because of the susceptibility of a structure such as a building or a bridge to damage from seismic activity, corrosion, and the like. This reinforcement is further desirable to upgrade the structure beyond its original design capacity. Methods to achieve such reinforcement are known. For example, in U.S. Pat. No. 6,003,276, Hegemier et al. describes a method for externally reinforcing a vertically extending cementitious wall having a base by contacting either or both faces of the wall with a fiber reinforced composite. After the surface of the face to which the reinforcement is to be affixed is cleaned, filled, and smoothed, a base strip of the fiber composite material is applied to the lower portion of the wall that connects with the base. The base strip is made of a composite material of fibers embedded in a curable matrix, and it is applied to the wall by any suitable manner. For example, the wall can be coated with a curable polymeric resin such as a 2-part epoxy resin, then a carbon cloth is placed on top of the polymeric resin, then another layer of the polymeric resin is rolled into the carbon cloth to achieve good wetting of the polymeric resin to the carbon. Additional polymeric resin is added and rolled into place as desired, after which the resin is cured in place, preferably at ambient temperature.

The carbon cloth may also be impregnated and wetted with the polymeric resin and then applied wet to the wall over a layer of previously applied polymeric resin, and thereafter cured. In a less preferred approach, the cloth may be impregnated with the epoxy and partially cured to form a prepreg and thereafter joined to the wall with an adhesive such as the polymeric resin. A curable polymer modified cementitious material can also be used.

The problem with the approach adopted by Hegemier et al. is that this “wallpaper” approach is slow, labor intensive, and has poor quality control due to the errors associated with mixing adhesive on site. Accordingly, it would be an advantage in the art of cementitious structure repair and reinforcement to find a method that is fast, inexpensive, and reliable.

### SUMMARY OF THE INVENTION

The present invention addresses the aforementioned problems in the field of cementitious structure repair by providing a method for repairing or reinforcing a cementitious structure comprising the steps of a) applying to the structure a multilamellar patch or wrapping that contains a fiber reinforcing layer in contact with a curable adhesive layer so that the curable adhesive layer is in contact with the structure; and b) curing the curable adhesive layer to bond the multilamellar structure to the cementitious structure.

In a second embodiment the invention is a method of reinforcing a cementitious structure comprising the steps of a) forming a groove at the surface of the structure; b) inserting into the groove a fiber-reinforced composite surrounded by a heat-curable resin; and c) heat curing the resin so that the composite bonds to the structure.

The method of the present invention provides a relatively fast, and efficient means to repair and reinforce cementitious structures.

### BRIEF DESCRIPTION OF THE DRAWINGS

FIG. 1 is an illustration of a composite surrounded by adhesive inserted into a preformed groove in a cementitious structure.

### DETAILED DESCRIPTION OF THE INVENTION

As used herein, the term “cementitious structure” is used to refer to cement or concrete walls or columns made of either masonry or poured construction. Cement also includes cement-like materials such as brick, adobe, and rock. The structure may include internal reinforcement such as reinforcing bars.

The multilamellar patch or wrapping contains a fiber reinforcing layer affixed to a curable adhesive layer. The fiber reinforcing layer is typically a woven, stitched, or braided fabric, but may also exist in other forms such as unidirectional or random fibers. The fiber is preferably carbon, glass, steel or aramid, but may also include other compositions. The curable adhesive can be any suitable adhesive including an epoxy or a urethane/epoxy/silicone IPN thermosetting adhesive such as those described in U.S. Pat. No. 4,803,105 (column 4, lines 60 to 68 and column 5, lines 1 to 44) and U.S. Pat. No. 4,842,938, which descriptions are incorporated herein by reference. An example of a commercially available pressure sensitive adhesive with fiberglass backing is BETABRACE™ reinforcing composite (a trademark of Essex Specialty Products, Inc.).

Examples of epoxy resins, which are preferred, include cycloaliphatic epoxides, epoxidized novolac resins, epoxidized bisphenol A or bisphenol F resin, and alkanediol diglycidyl ethers such as butanediol diglycidyl ether or neopentylglycol diglycidyl ether. Another example of a preferred epoxy resin includes the reaction product of the diglycidyl ether of bisphenol A or bisphenol F and a carboxy-terminated butadiene acrylonitrile, which produces a crosslinkable resin with improved peel strength. Examples of suitable curing agents include Lewis acids, imidazoles, and dicyandiamide, with dicyandiamide being preferred.

The curable adhesive layer may include a plasticizer for impact and thermal shock resistance improvement. Examples of suitable plasticizers include benzoates, adipates, and phthalates, with phthalates such as dibutyl phthalate being preferred. The adhesive layer may also include a flame retardant, a flow control agent such as clay or fumed silica, or a filler such as glass, phenolic or aluminum oxide bubbles, talc, carbonates, silicates, and the like. The adhesive layer may also include other forms of reinforcement such as short fibers to improve the mechanical properties of the adhesive layer.

The thermosetting adhesive cures typically in the range of from about 160° C. to about 220° C., but the curing temperature can be reduced to from about 120° C. to about 180° C. when a catalyst such as a substituted urea (for example, phenyl dimethyl urea) is present.

The thickness of the thermosetting adhesive layer is sufficient to provide adhesion and to provide a matrix for the fiber, preferably from about 0.2 mm to about 5 mm.

In the method of the present invention, the adhesive layer portion of the multilamellar patch or wrapping is placed in contact with the cementitious structure, typically a building or a column, at the site where damage has occurred. Alternatively, the patch or wrapping can be used as prophylactic reinforcement. The patch or wrapping is then heat cured by any suitable means such as a heat blanket, a heat lamp, heating tape, infrared heating, hot air heating, and the like. Upon heating, the adhesive becomes sufficiently liquid to flow through and impregnate the cloth. A rigid composite is formed upon cooling with concomitant adhesion to the structure. As the adhesive impregnates the cloth, the color and appearance of the cloth changes, thus making it obvious that sufficient wet out has occurred.

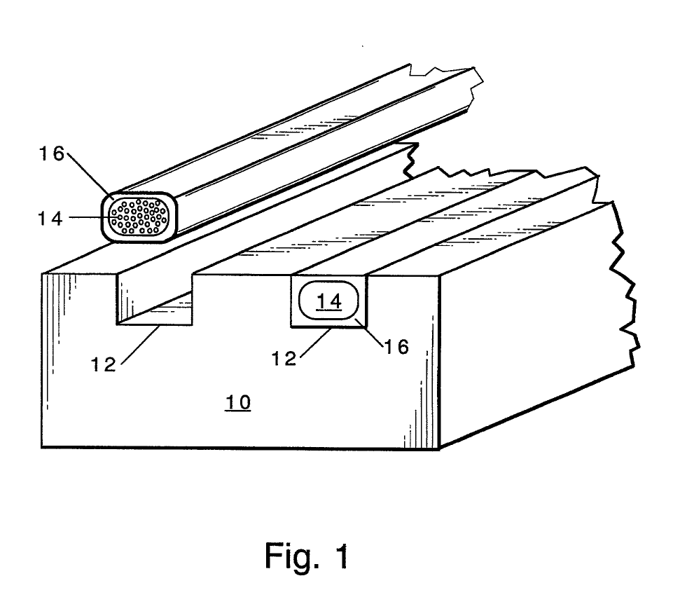

In another embodiment of the present invention, an elongated fiber-reinforced composite surrounded by a layer of heat curable adhesive can be inserted into a pre-formed groove of the cementitious structure, then heat cured. FIG. 1, which is an illustration of this embodiment, shows a cementitious structure (10) having a groove (12) into which is placed the fiber-reinforced thermoplastic or thermoset composite (14) surrounded by the heat curable adhesive (16). In this embodiment, the reinforcing fibers are preferably glass, carbon, steel, or aramid fibers that longitudinally extend through the length of the composite (14).

Where the composite contains a thermoset matrix, it is preferably a polyester, vinyl ester, or epoxy. Thermoset composites can be prepared by pultrusion methods well known in the art. Thermoplastic composites can also be prepared by a more specialized process such as the one described by Edwards et al. in U.S. Pat. No. 6,165,604.

Where the resin is a thermoplastic, it is preferably an engineering thermoplastic polyurethane having a T_{g} of at least 50° C. A thermoplastic reinforced composite has the additional advantage of being preformable into shapes that can be used to further enhance reinforcement. For example, the thermoplastic composite can be preformed into a “U” shape and bonded into the cementitious structure through the curable adhesive to create greater mechanical locking. Additionally, a thermoplastic composite can be preformed to follow corners or complex curves in the structure.

To enhance tensile strength of the cementitious structure, the composite rod or multilamellar patch or wrapping can be tensioned while the adhesive layer is cured, then released from tension, thereby producing a compressive stress within the structure.

The method of the present invention provides for a fast and efficient means of reinforcing or repairing cementitious structures. Although the method of the present invention is directed to the reinforcement or repair of cementitious structures, the method of reinforcement can also be used for other structures such as wood, steel, or composite structures.

What is claimed is:

1. A method for repairing or reinforcing a cementitious structure comprising the steps of a) applying to the structure a multilamellar patch or wrapping that contains a fiber reinforcing layer in contact with a curable adhesive layer so that the curable adhesive layer is in contact with the structure; and b) curing the curable adhesive layer to bond the multilamellar structure to the cementitious structure.

2. The method of claim 1 wherein the curable adhesive layer includes an epoxy resin and a curing agent selected from the group consisting of a Lewis acid, an imidazole, and dicyandiamide.

3. The method of claim 2 wherein the curing agent is dicyandiamide.

4. The method of claim 2 wherein the epoxy resin is the reaction product of diglycidyl ether of bisphenol A or bisphenol F and a carboxy-terminated butadiene acrylonitrile.

5. The method of claim 3 which further includes a substituted urea as a catalyst.

6. The method of claim 1 wherein the multilamellar patch or wrapping is tensioned as the adhesive cures

7. A method of reinforcing a cementitious structure comprising the steps of a) forming a groove at the surface of the structure; b) inserting into the groove a fiber-reinforced composite surrounded by a heat-curable resin; and c) heat curing the resin so that the composite bonds to the structure.

8. The method of claim 7 wherein the fiber-reinforced composite contains a thermoset matrix.

9. The method of claim 8 wherein the thermoset matrix is a polyester, a vinyl ester, or an epoxy.

10. The method of claim 7 wherein the fiber-reinforced composite contains a thermoplastic matrix

11. The method of claim 7 wherein the fibers are glass, steel, aramid, or carbon fibers.

12. The method of claim 10 wherein the thermoplastic matrix includes a thermoplastic polyurethane having a T_{g} of at least 50° C.

13. The method of claim 12 wherein the fibers are aligned longitudinally extending through the length of the composite.

14. The method of claim 10 wherein the thermoplastic composite is shaped to enhance mechanical strength or to follow the contours of the cementitious structure.

15. The method of claim 7 wherein the composite is tensioned as the adhesive cures.
